(19) United States
(12) Patent Application Publication
(10) Pub. No.: US 2009/0059424 A1
(43) Pub. Date: Mar. 5, 2009

(54) MAGNETIC HEAD, MAGNETIC RECORDING MEDIUM, AND MAGNETIC RECORDING APPARATUS USING THE MAGNETIC HEAD AND MAGNETIC RECORDING MEDIUM

(75) Inventors: Yong-su Kim, Seoul (KR); Kook-hyun Sunwoo, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/111,994

(22) Filed: Apr. 30, 2008

(30) Foreign Application Priority Data
Aug. 29, 2007 (KR) 10-2007-0087309

(51) Int. Cl. G11B 5/17; G11B 5/82

(52) U.S. Cl. 360/123.01; 360/135

(57) ABSTRACT

Provided are a magnetic head, a magnetic recording medium, and a magnetic recording apparatus using the magnetic head and the magnetic recording medium. The magnetic head is used for magnetically recording data on a magnetic recording medium and includes a main pole; a return-yoke forming a magnetic path along with the main pole; a coil for inducing a magnetic field to emit a magnetic field for magnetic recording through an end tip of the main pole near a magnetic recording medium; and an insulating layer for electrically insulating the main pole from the return-yoke. The main pole is electrically connected to an external device and generates an electric field for assisting magnetic recording along the magnetic field for magnetic recording. In this structure, the coercive force of a magnetic recording layer can be reduced during magnetic recording so that data can be recorded at high density.

### CROSS-REFERENCE TO RELATED PATENT APPLICATION

This application claims the benefit of Korean Patent Application No. 10-2007-0087309, filed on Aug. 29, 2007, in the Korean Intellectual Property Office, the disclosure of which is incorporated herein in its entirety by reference.

### BACKGROUND OF THE INVENTION

1. Field of the Invention

The present invention relates to a magnetic head, a magnetic recording medium, and a magnetic recording apparatus using the magnetic head and magnetic recording medium, and more particularly, to a magnetic head, which can reduce coercive force of a magnetic recording medium during recording so as to record data at high density, a magnetic recording medium, and a magnetic recording apparatus using the magnetic head and magnetic recording medium.

2. Description of the Related Art

Nowadays, owing to a rapid increase in the amount of data to be processed, data storage devices that can record and reproduce data at higher density are being required. In particular, since a magnetic recording apparatus using a magnetic recording medium, such as a hard-disk drive, is a mass storage having a high-speed access characteristic, it has attracted much attention as a data storage device used for not only computers but also various digital devices.

As the recording density of magnetic recording mediums increases, the bit size thereof decreases. However, a signal magnetic field generated by the magnetic recording medium is reduced with the decrease in the bit size, and thus it is necessary to reduce noise in order to ensure a high signal-to-noise ratio (SNR) during reproduction. The noise is mostly made by a magnetization transition unit of the magnetic recording medium. Therefore, transition noise is reduced by lessening the size of crystal grains constituting a recording bit, so that a high SNR may be ensured.

Meanwhile, the spin of each crystal grain is not affected by thermal fluctuations but should maintain a recorded direction so that a magnetic recording medium can stably retain recorded data. In order to ensure thermal stability of the magnetic recording medium, the magnetic recording medium needs to be formed of a magnetic material having a high anisotropic magnetic field Hk or a high coercive force Hc.

As described above, when a magnetic recording medium is formed of a magnetic material having a high anisotropic magnetic field Hk or a high coercive force Hc, a magnetic head should have a high magnetic flux density or a high field gradient. Furthermore, since a data rate at which data is recorded and reproduced needs to be increased with a rise in recording density, the dynamic coercivity of the magnetic recording medium also increases. As a result, the magnetic flux density and the field gradient of the magnetic head should be further increased. However, it is known that a saturation magnetic field Bs of a magnetic body has a physical limit of 3.0 T or more, and thus there is a specific limit in increasing the magnetic flux density and magnetic gradient of the magnetic head. Therefore, research has been conducted on developing a magnetic head having an optimized shape and a method of manufacturing the magnetic head to increase recording density and recording speed. However, this research is making little progress and related techniques become almost saturated, so that there is not much possibility of the research progressing.

Thus, although a heat assisted recording (HAMR) storage device and a radio-frequency magnetic recording (RFMR) storage device that may magnetically record data in a magnetic recording medium having a high anisotropic magnetic field Hk or a high coercive force Hc at a low magnetic flux density have been proposed as subsidiary magnetic recording units, a specific, practicable method of adding a heat source or an RF source to a magnetic head having a complicated structure was not taught yet.

In recent years, a magnetic material whose coercive force is reduced when an electric field is applied thereto has been reported. Also, it has lately been known that when a voltage is applied to a multiferroic material having both ferromagnetic and ferroelectric properties at a normal temperature, the coercive force of the multiferroic material is reduced (F. Zavaliche et al., Nano Letter 2005. 8. 26; F. Zavaliche et al., Nano Letter 2007. 5. 11).

### SUMMARY OF THE INVENTION

The present invention provides a magnetic head, a magnetic recording medium, and a magnetic recording apparatus using the magnetic head and magnetic recording medium, which can record data at high density by lowering the coercive force of a magnetic recording layer.

According to an aspect of the present invention, there is provided a magnetic head for magnetically recording data on a magnetic recording medium. The magnetic head includes: a main pole; a return-yoke forming a magnetic path along with the main pole; a coil for inducing a magnetic field to emit a magnetic field for magnetic recording through an end tip of the main pole near a magnetic recording medium; and an insulating layer for electrically insulating the main pole from the return-yoke. The main pole is electrically connected to an external device and generates an electric field for assisting magnetic recording along the magnetic field for magnetic recording.

According to another aspect of the present invention, there is provided a magnetic recording medium including: a substrate; a conductive layer disposed on the substrate; and a magnetic recording layer disposed on the conductive layer. The magnetic recording layer is formed of a multiferroic material having coercive force that is reduced due to an electric field.

According to yet another aspect of the present invention, there is provided a magnetic recording apparatus including a magnetic recording medium and a magnetic head. The magnetic recording medium includes: a conductive layer; a magnetic recording layer; and a protection layer that are sequentially stacked on a substrate. The magnetic recording layer is formed of a multiferroic material having coercive force that is reduced due to an electric field. The magnetic head is used for magnetically recording data on the magnetic recording medium. The magnetic head includes a main pole; a return-yoke; a coil; and an insulating layer. The main pole is electrically connected to an external device and generates an electric field for assisting magnetic recording along the magnetic field for magnetic recording. The return-yoke forms a magnetic path along with the main pole. The coil induces a magnetic field to emit a magnetic field for magnetic recording through an end tip of the main pole near a magnetic recording medium. The insulating layer electrically insulates the main pole from the return-yoke. In the magnetic recording apparatus, a voltage is applied to at least one of the conductive layer and the main pole such that an electric field is generated between the end tip of the main pole near the magnetic recording medium and the conductive layer.

As described above, the magnetic head, the magnetic recording medium, and the magnetic recording apparatus using the magnetic head and the magnetic recording medium can reduce coercive force using an electrical assisting unit so that data can be magnetically recorded at high speed.

### BRIEF DESCRIPTION OF THE DRAWINGS

The above and other features and advantages of the present invention will become more apparent by describing in detail exemplary embodiments thereof with reference to the attached drawings in which:

FIG. 1 is an atomic force microscope (AFM) image showing a nanostructure of a BiFeO₃—CoFe₂O₄ thin layer that can be used for a magnetic recording medium according to an embodiment of the present invention;

FIG. 2 is a graph showing a magnetization curve of the BiFeO₃—CoFe₂O₄ thin layer shown in FIG. 1;

FIG. 3 is a view showing the construction of a magnetic force microscopy (MFM) scan of the BiFeO₃—CoFe₂O₄ thin layer shown in FIG. 1;

FIG. 4A is an MFM image obtained when not an electric field but a weak magnetic field is applied to the BiFeO₃—CoFe₂O₄ thin layer shown in FIG. 1;

FIG. 4B is an MFM image obtained when both an electric field and a weak magnetic field are applied to the BiFeO₃—CoFe₂O₄ thin layer shown in FIG. 1;

FIG. 5 illustrates a magnetic recording apparatus according to an embodiment of the present invention;

FIG. 6 illustrates a magnetic recording medium used for the magnetic recording apparatus shown in FIG. 5;

FIG. 7 illustrates a magnetic head used for the magnetic recording apparatus shown in FIG. 5; and

FIGS. 8 and 9 illustrate modified examples of the magnetic head shown in FIG. 7.

### DETAILED DESCRIPTION OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to one skilled in the art. In the drawings, the thicknesses of layers and regions are exaggerated for clarity. The same reference numerals are used to denote the same elements throughout the specification.

At the outset, a multiferroic material used for a magnetic recording medium according to the present invention will be described.

A multiferroic material refers to a material having both a ferromagnetic property and a ferroelectric property in which one order of spontaneous magnetization caused by the ferromagnetic property and spontaneous polarization caused by the ferroelectric property is changed by controlling the other order thereof. For example, the magnetic property of a multiferroic material may be changed by applying an electric field to the multiferroic material as described later. A multiferroic material according to the present invention has multiferroic properties at a normal temperature, for example, BiFeO₃—CoFe₂O₄.

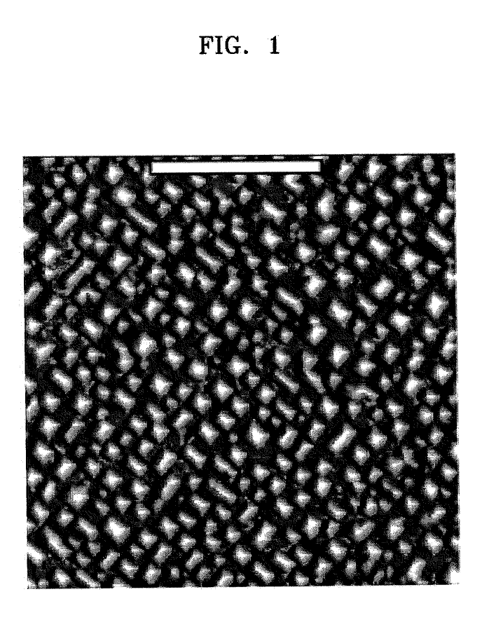

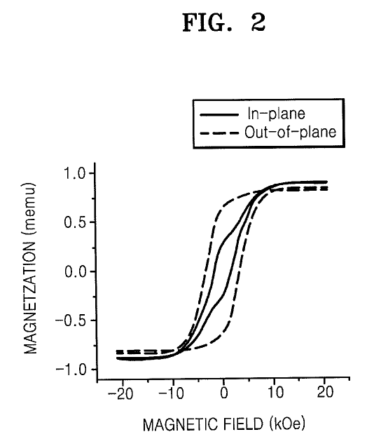

FIG. 1 is an atomic force microscope (AFM) image showing a nanostructure of a thin layer formed of BiFeO₃—CoFe₂O₄ that is a multiferroic material, and FIG. 2 is a graph showing a magnetization curve of the BiFeO₃—CoFe₂O₄ thin layer shown in FIG. 1.

Referring to FIG. 1, it can be observed that a nanopillar is formed in a BiFeO₃ epitaxial matrix. Since growth of the BiFeO₃—CoFe₂O₄ thin layer is well known, a detailed description thereof will be omitted here. In FIG. 2, an in-plane magnetization of the BiFeO₃—CoFe₂O₄ thin layer is illustrated with a solid curve, and an out-of-plane magnetization of the BiFeO₃—CoFe₂O₄ thin layer is illustrated with a dotted curve. Referring to FIG. 2, the BiFeO₃—CoFe₂O₄ thin layer has a vertical magnetic anisotropy so that the out-of-plane magnetization of the BiFeO₃—CoFe₂O₄ thin layer is easier than the in-plane magnetization thereof in response to an external magnetic field.

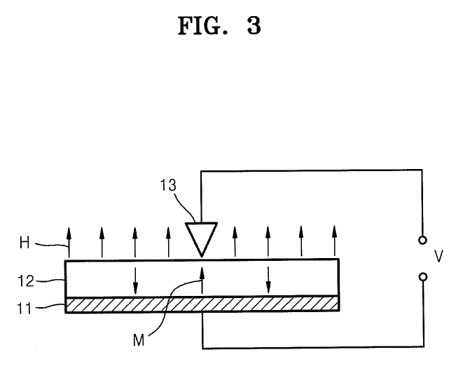

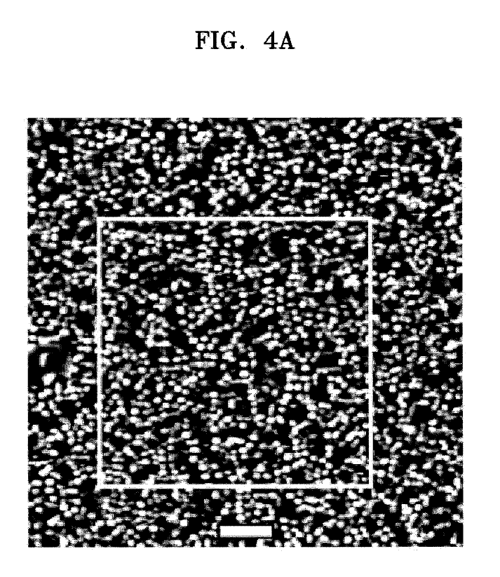

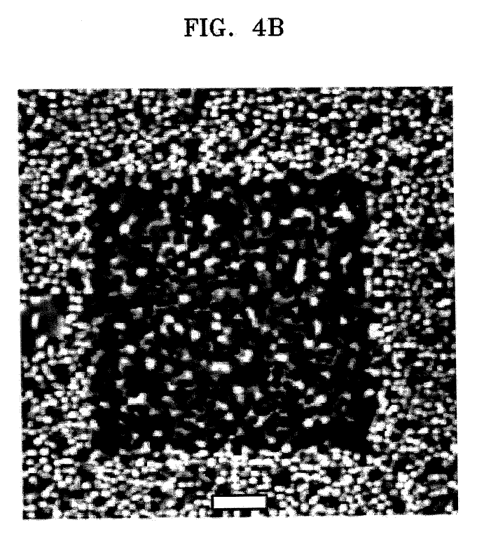

Hereinafter, multiferroic properties of the BiFeO₃—CoFe₂O₄ thin layer will be described with reference to FIGS. 3 and 4A and 4B.

Referring to FIG. 3, a surface of a BiFeO₃—CoFe₂O₄ thin layer 12 formed on a conductive substrate 11 is scanned using a magnetic force microscopy (MFM) probe 13. In this case, the BiFeO₃—CoFe₂O₄ thin layer 12 is magnetized in a direction (refer to M), and an electric field H is applied in an opposite direction to the magnetized direction M outside the BiFeO₃—CoFe₂O₄ thin layer 12. Meanwhile, when a voltage V is applied to the MFM probe 13 and the conductive substrate 11 is grounded, an electric field is applied to the BiFeO₃—CoFe₂O₄ thin layer 12.

FIGS. 4A and 4B are MFM images showing multiferroic properties of the BiFeO₃—CoFe₂O₄ thin layer, which are measured using the construction shown in FIG. 3. Specifically, FIG. 4A is an MFM image obtained when an upward magnetic field having an intensity of 700 Oe smaller than a coercive force of about 3.5 kOe is applied to the BiFeO₃—CoFe₂O₄ thin layer that is magnetized downward. FIG. 4B is an MFM image obtained when an upward magnetic field having an intensity of 700 Oe and an electric field are applied to the BiFeO₃—CoFe₂O₄ thin layer that is magnetized downward. In FIG. 4A, bright spots denote CoFe₂O₄ nanopillars that are magnetized downward. In FIG. 4B, dark spots denote CoFe₂O₄ nanopillars that are magnetized upward. Referring to FIGS. 4A and 4B, when only the magnetic field is applied, magnetization reversal hardly occurs; on the other hand, when both the magnetic field and the electric field are applied, magnetization reversal occurs. That is, the coercive force of a region to which the magnetic field and the electric field are both applied is reduced so that the magnetization of the region is easily reversed.

According to the present invention, a magnetic recording layer is formed of a multiferroic material having coercive force that is reduced when both a magnetic field and an electric field are applied thereto. Thus, the present invention provides a magnetic head, a magnetic recording medium, and a magnetic recording apparatus using the magnetic head and the magnetic recording medium, which enable electrically assisted magnetic recording.

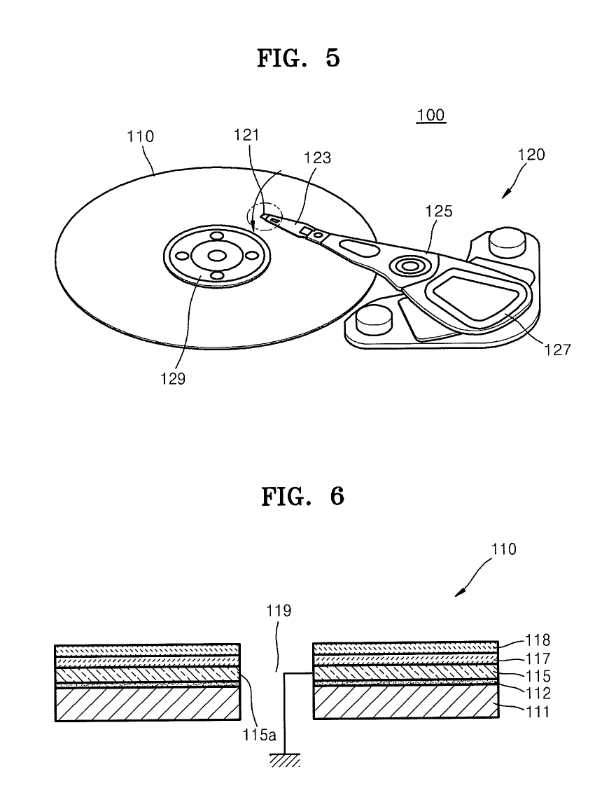

A magnetic head, a magnetic recording medium, and a magnetic recording apparatus using the magnetic head and the magnetic recording medium according to an embodiment of the present invention will now be described with reference to FIGS. 5 through 7.

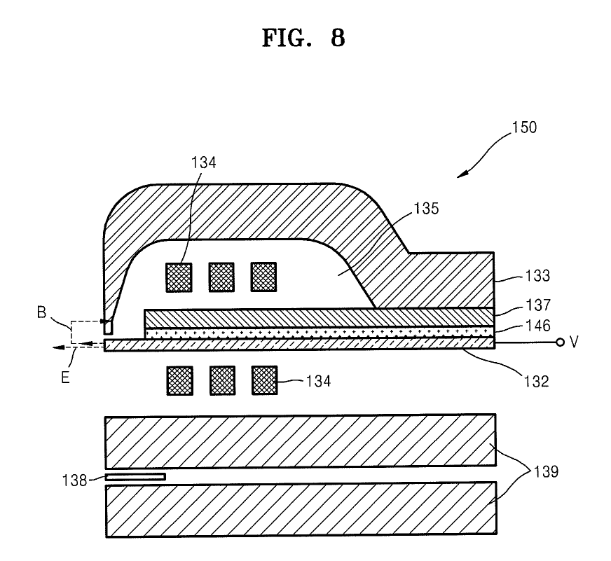

Referring to FIG. 5, a magnetic recording apparatus 100 according to the present invention includes a magnetic recording medium 110, a driving unit (not shown) for driving the magnetic recording medium 110, and an actuator 120 on which a magnetic head (refer to 130 in FIG. 7) for magnetically recording data in the magnetic recording medium 110 is installed.

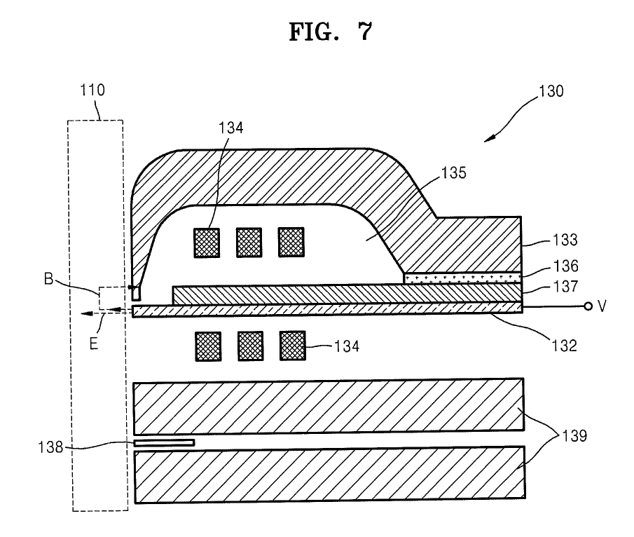

Referring to FIG. 6, the magnetic recording medium 110 according to the current embodiment includes a crystalline orientation layer 112, a conductive layer 115, a magnetic recording layer 117, and a protection layer 118, which are sequentially stacked on a disk-shaped substrate 111. In addition, various layers for improving crystallinity of the magnetic recording layer 117 or inhibiting noise may be further provided. For example, an intermediate layer (not shown) may be further provided to reduce a difference in crystalline structure between the conductive layer 115 and the magnetic recording layer 117 to improve recording performance.

The substrate 111 may be formed of glass or an aluminum (Al) alloy and has the shape of a disk with a central connection hole 119.

The crystalline orientation layer 112 is used to improve crystalline orientation of the magnetic recording layer 117 and enables a magnetic easy axis of the magnetic recording layer 117 to be arranged in a vertical direction to a membrane surface and have a vertical magnetic anisotropic energy. Although the current embodiment describes that the crystalline orientation layer 112 is interposed between the substrate 111 and the conductive layer 115, the present invention is not limited thereto. For instance, the crystalline orientation layer 112 may be interposed between the conductive layer 115 and the magnetic recording layer 117.

The conductive layer 115 may have a surface 115a that is exposed to the connection hole 119, so that the conductive layer 115 can be externally grounded. The exposed surface 115a may be in gear with a hub (refer to 129 in FIG. 5) of the driving unit and grounded to the magnetic recording apparatus (refer to 100 in FIG. 5). Meanwhile, the conductive layer 115 may be formed of a conductive soft-magnetic material, such as FeSiAl, a NiFe alloy, or a CoZr alloy. In this case, the conductive layer 115 functions as a soft-magnetic underlayer that acts as a return path of a magnetic field generated by the magnetic head 130 to form a magnetic path of a vertical magnetic field.

The magnetic recording layer 117 is formed of a multiferroic material having coercive force that is reduced due to an electric field, for example, BiFeO₃—CoFe₂O₄. For example, formation of the magnetic recording layer 117 may include depositing a BiFeO₃—CoFe₂O₄ layer using pulsed laser deposition (PLD) and epitaxially growing the deposited BiFeO₃—CoFe₂O₄ layer. The protection layer 118 is formed on the magnetic recording layer 117. The protection layer 118 may be formed using at least one of diamond-like carbon (DLC) and a lubricant used for the surface of a typical hard disk.

Referring again to FIG. 5, the driving unit is used to rotate the magnetic recording medium 110. The driving unit includes the hub 129, which combines with the connection hole (refer to 119 in FIG. 6) of the magnetic recording medium 110, and a spindle motor (not shown), which rotates the hub 129. The hub 129 is in contact with the surface 115a of the conductive layer 115, which is exposed to the connection hole 119, so that the hub 129 is electrically connected to the conductive layer 115. The hub 129 is electrically connected to a main body (e.g., a case) of the magnetic recording apparatus 100 using a bearing (not shown). Thus, the conductive layer 115 of the magnetic recording medium 110 may be grounded to the main body of the magnetic recording apparatus 100. The actuator 120 includes an actuator arm 125 and a suspension 123 that extends from the actuator arm 125. A slider 121 on which the magnetic head 130 is installed is attached to an end tip of the suspension 123. The slider 121 is driven by a voice coil motor (VCM) 127.

Hereinafter, the magnetic head 130 used for the magnetic recording apparatus 100 will be described with reference to FIG. 7.

The magnetic head 130 is used to magnetically record data in the magnetic recording medium 110. The magnetic head 130 includes a main pole 132, a return-yoke 133 that forms a magnetic path along with the main pole 132, a coil 134 for inducing a magnetic field B for magnetic recording to emit the magnetic field B through an end tip of the main pole 132 near the magnetic recording medium 110, and an insulating layer 136 for electrically insulating the main pole 132 from the return-yoke 133. The magnetic head 130 may further include a sub-yoke 137, which aids magnetic flux to focus on the end tip of the main pole 132 near the recording medium 110. Also, in order to read data recorded in the recording medium 110, the magnetic head 130 may further include a reproduction head unit including two magnetic shield layers 139 and a magneto-resistance (MR) device 138 interposed between the magnetic shield layers 139. A portion 135 is filled with Al₂O₃ or other insulating material not to leak current from the coil 134. The coil 134 for inducing the magnetic field B toward the main pole 132 may be formed as a solenoid type as illustrated in FIG. 7 or a spiral type.

The main pole 132, the return-yoke 133, and the sub-yoke 137 are formed of a magnetic material to form a magnetic path of the magnetic field B generated by the coil 134. In this case, since the intensity of a magnetic field focused on the end tip of the main pole 132 is restricted by a saturation flux density of the main pole 132, the main pole 132 is formed of a magnetic material having a saturation flux density higher than that of the return-yoke 133 or the sub-yoke 137. Furthermore, the main pole 132 is electrically connected to an external device so that a voltage V can be applied to the main pole 132. That is, the magnetic head 130 according to the current embodiment includes a plurality of terminals (not shown) that are electrically connected to an external device, so that not only the coil 134 and the MR device 138 but also the main pole 132 can be electrically connected to the external device.

When the voltage V is applied to the main pole 132, an electric field E for assisting magnetic recording may be emitted toward the magnetic recording medium 110 through the end tip of the main pole 132. The main pole 132 may be formed of a highly conductive magnetic material to minimize a voltage drop in the main pole 132. For example, the main pole 132 may be formed of NiFe, CoFe, or CoNiFe. The sub-yoke 137 and the return-yoke 133 may be formed to have a higher magnetic permeability than the main pole 132 so that the sub-yoke 137 or the return-yoke 133 can have high-speed response to a change in radio-frequency (RF) magnetic field. The sub-yoke 137 and the return-yoke 133 may be formed of NiFe, and the magnetic head 130 may have appropriate saturation flux density and magnetic permeability by controlling a content ratio of Ni to Fe.

An end tip of the return-yoke 133 near the magnetic recording medium 110 is formed apart from the main pole 132. In this case, a gap between the end tip of the return-yoke 133 and the end tip of the main pole 132 is appropriately determined such that a magnetic field B generated by the main pole 132 magnetizes the magnetic recording layer (refer to 117 in FIG. 6) of the magnetic recording medium 110 and forms a return path. Further, a distance between the end tip of the main pole 132 and the conductive layer 115 may be smaller than a distance between the end tip of the main pole 132 and the end tip of the return-yoke 133 such that an electric field generated by the end tip of the main pole 132 proceeds to the conductive layer (refer to 115 in FIG. 6) of the magnetic recording medium 110. A distance between the end tip of the main pole 132 and the magnetic recording medium 110 may be several tens of nm or less, and the gap between the end tip of the return-yoke 133 and the end tip of the main pole 132 may be several hundred nm.

The sub-yoke 137 aids a magnetic field to focus on the end tip of the main pole 132. The sub-yoke 137 may be formed on a surface of the main pole 132 that faces the return-yoke 133, and spaced a predetermined distance apart from the end tip of the main pole 132. In this case, the insulating layer 136 may be prepared in a back gap region where the sub-yoke 137 makes a magnetic junction with the return-yoke 133. The insulating layer 137 may be formed of an insulating soft-magnetic material, such as a polymer magnetic material, such that the main pole 132 is electrically insulated from the return-yoke 133 but a magnetic path is maintained between the main pole 132 and the return-yoke 133.

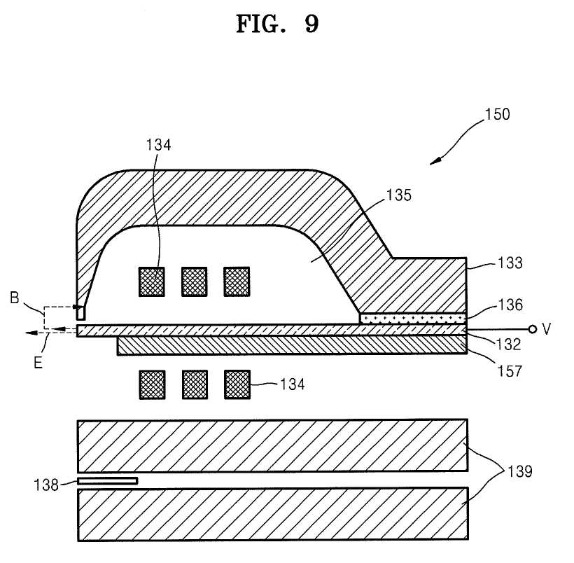

The position of the insulating layer 136 is not limited to an interface between the sub-yoke 137 and the return-yoke 133. For example, as illustrated in FIG. 8, an insulating layer 146 may be interposed between the main pole 132 and the sub-yoke 137.

FIG. 9 illustrates a case where a sub-yoke 157 is formed on a reverse surface of a bottom surface of a main pole 132 that faces a return-yoke 133. In this case, an insulating layer 136 is prepared in a back gap region that magnetically connects the main pole 132 and the return-yoke 133. A magnetic head according to the present invention may not include the sub-yoke 157. Thus, when the sub-yoke 157 is not formed, the insulating layer 1136 is prepared at an interface (i.e., the back gap region) between the main pole 132 and the return-yoke 133 in about the same manner as shown FIG. 9. In FIGS. 8 and 9, the same reference numerals are used to denote the same elements as in the magnetic head 130 of FIG. 7, and a description thereof will be omitted here.

The embodiments of the present invention have described various structures of the magnetic head, the magnetic recording medium, and the magnetic recording apparatus using the magnetic head and the magnetic recording medium. The magnetic head according to the present invention insulates the main pole from the return-yoke so that the main pole can be used as an electrode that generates both a magnetic field and an electric field. The magnetic recording medium according to the present invention includes the magnetic recording layer, which is formed of a multiferroic material having coercive force that is reduced in response to an electric field. As described above, the electric field and the magnetic field are generated at the same time through the main pole, and thus the electric field can be used as an assistant to reduce the coercive force of the magnetic recording layer, and data can be magnetically recorded on the magnetic recording layer using a lower magnetic field.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A magnetic head for magnetically recording data on a magnetic recording medium, the magnetic head comprising:
a main pole;
a return-yoke forming a magnetic path along with the main pole;
a coil for inducing a magnetic field to emit a magnetic field for magnetic recording through an end tip of the main pole near a magnetic recording medium; and
an insulating layer for electrically insulating the main pole from the return-yoke,
wherein the main pole is electrically connected to an external device and generates an electric field for assisting magnetic recording along the magnetic field for magnetic recording.

2. The magnetic head of claim 1, wherein the insulating layer is disposed in a back gap region that magnetically connects the main pole and the return-yoke.

3. The magnetic head of claim 1, further comprising a sub-yoke spaced a predetermined distance apart from the end tip of the main pole to focus a magnetic field on the end tip of the main pole.

4. The magnetic head of claim 3, wherein the sub-yoke is formed on a surface of the main pole that faces the return-yoke,
wherein the insulating layer is interposed between the main pole and the sub-yoke or between the return-yoke and the sub-yoke.

5. The magnetic head of claim 3, wherein the sub-yoke is formed on a reverse surface of a surface of the main pole that faces the return-yoke,
wherein the insulating layer is disposed in a back gap region that magnetically connects the main pole and the return-yoke.

6. The magnetic head of claim 1, wherein the main pole is formed of a conductive material.

7. The magnetic head of claim 1, wherein the insulating layer is formed of a soft-magnetic material.

8. A magnetic recording medium comprising:
a substrate;
a conductive layer disposed on the substrate; and
a magnetic recording layer disposed on the conductive layer,
wherein the magnetic recording layer is formed of a multiferroic material having coercive force that is reduced due to an electric field.

9. The magnetic recording medium of claim 8, wherein the magnetic recording layer is formed of BiFeO₃—CoFe₂O₄.

10. The magnetic recording medium of claim 8, further comprising a connection hole prepared in the center thereof,
wherein the conductive layer is exposed by the connection hole.

11. The magnetic recording medium of claim 8, wherein the conductive layer is formed of a conductive soft-magnetic material.

12. A magnetic recording apparatus comprising:
a magnetic recording medium including a conductive layer, a magnetic recording layer, and a protection layer that are sequentially stacked on a substrate, the magnetic recording layer formed of a multiferroic material having coercive force that is reduced due to an electric field; and
a magnetic head used for magnetically recording data on the magnetic recording medium, the magnetic head comprising: a main pole electrically connected to an external device to generate an electric field for assisting magnetic recording along the magnetic field for magnetic recording; a return-yoke forming a magnetic path along with the main pole; a coil for inducing a magnetic field to emit a magnetic field for magnetic recording through an end tip of the main pole near a magnetic recording medium; and an insulating layer for electrically insulating the main pole from the return-yoke,
wherein a voltage is applied to at least one of the conductive layer and the main pole such that an electric field is generated between the end tip of the main pole near the magnetic recording medium and the conductive layer.

13. The apparatus of claim 12, wherein the magnetic recording layer is formed of BiFeO₃—CoFe₂O₄.

14. The apparatus of claim 12, further comprising a driving unit for driving the magnetic recording medium,
wherein the magnetic recording medium includes a connection hole prepared in the center thereof and is connected to the driving unit through the connection hole,
and the conductive layer is exposed by the connection hole and electrically connected to the driving unit.

15. The apparatus of claim 12, wherein the conductive layer is grounded to a main body of the magnetic recording apparatus through the driving unit.

16. The apparatus of claim 12, wherein the conductive layer is formed of a conductive and soft-magnetic material.

17. The apparatus of claim 12, wherein the insulating layer is disposed in a back gap region that magnetically connects the main pole and the return-yoke.

18. The apparatus of claim 13, further comprising a sub-yoke spaced a predetermined distance apart from the end tip of the main pole to focus a magnetic field on the end tip of the main pole.

19. The apparatus of claim 18, wherein the sub-yoke is formed on a surface of the main pole that faces the return-yoke,
wherein the insulating layer is interposed between the main pole and the sub-yoke or between the return-yoke and the sub-yoke.

20. The apparatus of claim 18, wherein the sub-yoke is formed on a reverse surface of a surface of the main pole that faces the return-yoke,
wherein the insulating layer is disposed in a back gap region that magnetically connects the main pole and the return-yoke.
